(19) United States
(12) Patent Application Publication
(10) Pub. No.: US 2008/0238881 A1
(43) Pub. Date: Oct. 2, 2008

(54) Shield for a digitizer sensor

(75) Inventors: Haim Perski, Hod-HaSharon (IL); Oran Tamir, Tel-Aviv (IL)

Correspondence Address: Martin D. Moynihan;PRTSI, Inc., P.O. Box 16446, Arlington, VA, 22215, US

(73) Assignee: N-trig Ltd., Kfar-Saba (IL)

(21) Appl. No.: 12/078,047

(22) Filed: Mar. 26, 2008

Related U.S. Application Data
(60) Provisional application No. 60/907,261, filed on Mar. 27, 2007.

(51) Int. Cl. G06F 3/041

(52) U.S. Cl. 345/173

(57) ABSTRACT

A digitizer comprises a sensor configured for detecting an object implemented for user input, the sensor including at least one transparent layer, circuitry connected to the sensor configured for processing signals detected on at least a portion of the sensor and a conductive shield configured for providing shielding over an area of the sensor that is not intended for user input.

### RELATED APPLICATION

This Application claims the benefit under section 35 U.S.C. §119(e) of U.S. Provisional Patent Application No. 60/907,261, filed on Mar. 27, 2007, the contents of which are hereby incorporated in its entirety.

### FIELD OF THE INVENTION

The present invention, in some embodiments thereof, relates to digitizer sensors and more particularly, but not exclusively, to electromagnetic shielding in digitizer sensors.

### BACKGROUND OF THE INVENTION

The use of Electro-Magnetic (EM) shielding and/or Radio Frequency (RF) shielding is well known. EM and/or RF shielding function to limiting the flow of electromagnetic fields between two locations, by separating them with a barrier made of conductive material. Typically it is applied to electronic circuitry enclosed in an electrical device to isolate the electrical device from radio frequency interference, noise from the electronic circuitry, parasitic capacitance, parasitic coupling between the different components in the electronic circuitry etc. Known conductive materials used for shielding include, inter alia, sheet metal, metal mesh and/or metallic ink.

Digitizing systems that allow a user to operate a computing device with a stylus and/or finger are known. Typically, a digitizer is integrated with a display screen, e.g. over-laid on the display screen, to correlate user input, e.g. stylus interaction and/or finger touch on the screen with the virtual information portrayed on it. Position detection of the stylus and/or finger detected provides input to the computing device and is interpreted as user commands. Typically, input to the digitizer sensor is based on EM transmission provided by the stylus touching the screen and/or capacitive means provided by the finger touching the screen.

U.S. Pat. No. 6,690,156 entitled “Physical Object Location Apparatus and Method and a Platform using the same” and U.S. Pat. No. 7,292,229 entitled “Transparent Digitizer” both of which are assigned to N-trig Ltd., the contents of both which are incorporated herein by reference, describe an electromagnetic method for locating physical objects on a FPD and a transparent digitizer that can be incorporated into an electronic device, typically over the active display screen. The digitizer sensor includes a matrix of vertical and horizontal conducting lines to sense an electric signal. Positioning the physical object at a specific location on the digitizer provokes a signal whose position of origin may be detected.

U.S. Patent Application Publication No. US20040155871 entitled “Touch Detection for a Digitizer” assigned to N-trig Ltd, which is incorporated herein by reference, describes a digitizing tablet system capable of detecting position of physical objects and/or fingertip touch using the same sensing conductive lines. Typically, the system includes a transparent sensor overlaid on a FPD. The digitizer's sensor includes a matrix of vertical and horizontal conducting lines to sense an electric signal. Touching the digitizer in a specific location provokes a signal whose position of origin may be detected.

U.S. Patent Application Publication No. US20050189154 entitled “Noise removal algorithm for digitizer systems” assigned to N-trig, which is incorporated herein by reference, describes methods for noise reduction comprising: sampling at least two detecting elements substantially simultaneously to obtain outputs and reducing the output on one element in accordance with the output on the other element.

U.S. Patent Application Publication No.US20020063694 entitled “Pen-Based Computer System” which is incorporated herein by reference, describes a liquid crystal, thin film transistor display with driver lines folded around a light pipe and a digitizer. The digitizer has grid routing lines folded around a shield where the shield is connected to a shield of the computer system electronics. The display drivers and grid controller are mounted inward of an edge of the display.

U.S. Pat. No. 4,290,052, entitled “Capacitive touch entry apparatus having high degree of personal safety” assigned to General Electric Company, which is incorporated herein by reference, describes a capacitive touch entry structure utilizes an array of at least one capacitive touch sensor fabricated upon a double-sided printed circuit board adhesively mounted upon a surface of a transparent insulative substrate. The structure optionally includes a conductive guard disposed adjacent to the substrate to shield at least the lead portions of the touch sensors from capacitive effects.

### SUMMARY OF THE INVENTION

An aspect of some embodiments of the present invention is the provision of shielding to shield an area of a digitizer sensor where object detection is not desired.

An aspect of some embodiments of the present invention is the provision of a digitizer comprising a sensor configured for detecting an object implemented for user input, the sensor including at least one transparent layer, circuitry connected to the sensor configured for processing signals detected on at least a portion of the sensor, and a conductive shield configured for providing shielding over an area of the sensor that is not intended for user input.

Optionally, the at least one transparent layer is patterned with conductive lines, to create a grid of conductive lines.

Optionally, the circuitry is connected to at least a portion of the conductive lines.

Optionally, the circuitry is connected to at least a portion of the conductive lines from a first face of the sensor array and the conductive shield is overlaid on the opposite face of the sensor array.

Optionally, at least some of the conductive lines are connected to a plurality of conductive pads at or near the edge of the sensor array, the conductive pads configured for establishing electrical contact with the circuitry.

Optionally, the conductive pads are formed on a first face of the sensor array and the conductive shield is overlaid on an opposite face of the sensor array and over at least an area defined by the conductive pads.

Optionally, the circuitry includes at least one differential amplifier configured for detecting a difference between at least one pair of conductive lines.

Optionally, wherein the conductive shield is at a uniform potential and is configured for canceling a difference between the at least one pair of conductive lines, wherein the difference is due to an object positioned in an area of the sensor not intended for user input.

Optionally, the at least one transparent layer is manufactured from foil or glass.

Optionally, the detecting is by a capacitive based detection.

Optionally, the conductive shield is configured for providing shielding over an area proximal to at least one edge of the sensor.

Optionally, the conductive shield is an integral part of the sensor.

Optionally, the conductive shield is an integral part of the digitizer.

Optionally, the digitizer comprises a cover film configured for providing a surface over which a user can interact with the sensor, wherein the conductive shield is applied between the cover film and the sensor.

Optionally, the digitizer comprises a cover film configured for providing a surface over which a user can interact with the sensor, wherein the conductive shield is applied on the surface over which a user can interact with the sensor.

Optionally, the circuitry includes at least one printed circuit board mounted on at least one edge of the sensor array.

Optionally, the conductive shield is applied on the sensor array proximal to two edges of the sensor array.

Optionally, the conductive shield is at a uniform potential.

Optionally, the sensor includes conductive lines forming a grid and wherein the conductive shield is applied on the sensor over an area extending beyond the area defined by the grid.

Optionally, the sensor is over-laid on a display screen and is configured for correlating the user input with visual information portrayed on the display.

Optionally, a portion of senor array extends beyond a viewing area of the display screen and wherein the conductive shield is configured for covering that portion of the sensor array.

Optionally, the digitizer sensor is integrated with a host computing device including a cover positioned over part of the sensor and wherein the conductive shield is applied on the cover.

Optionally, the conductive shield is formed from a transparent material.

Optionally, the conductive shield is connected to ground.

Optionally, the conductive shield is electrically connected to the circuitry.

Optionally, the object is selected from a group including a finger, a stylus, a capacitive object and an electrostatic object.

Optionally, the digitizer is configured for detecting both finger touch and stylus input.

Optionally, the sensor array includes at least two transparent layers, each layer patterned with conductive lines, wherein the transparent layers are combined to create a grid of conductive lines.

Optionally, the conductive shield is a graphical print applied on one or more edges of the sensor.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A shows an exemplary simplified block diagram of a digitizer system in accordance with some embodiments of the present invention;

FIG. 1B showing pairs of conductive lines of digitizer sensor connected to differential amplifiers in accordance with some embodiments of the present invention;

FIG. 2A shows a simplified diagram of one face of sensor array including conductive pads on two edges of the sensor array and Printed Circuit Boards (PCBs) prior to connection, in accordance with some embodiments of the present invention;

FIG. 2B shows a simplified diagram of the opposite face of the sensor array shown in FIG. 2A including conductive shielding over the conductive pads, in accordance with some embodiments of the present invention;

FIG. 3 shows a simplified cross sectional view of the sensor array with PCB including shielding in accordance with some embodiments of the present invention;

FIG. 4 shows a simplified cross sectional view of the sensor module including shielding and overlaid on an FPD display in accordance with some embodiments of the present invention;

FIG. 5A shows a simplified diagram of one face of a sensor array including conductive pads on all edges of the sensor array and two PCBs prior to connection, in accordance with some embodiments of the present invention;

FIG. 5B shows a simplified diagram of the opposite face of the sensor array shown in FIG. 5A including conductive including conductive shielding over the conductive pads, in accordance with some embodiments of the present invention;

FIG. 6 shows a simplified cross sectional view of the sensor module including shielding on opposite ends of the sensor array overlaid on an FPD display in accordance with some embodiments of the present invention; and

FIG. 7 shows a sensor module including a frame covering with shielding in accordance with some embodiments of the present invention.

### DESCRIPTION OF SPECIFIC EMBODIMENTS OF THE INVENTION

The present invention, in some embodiments thereof, relates to digitizing sensors and more particularly, but not exclusively, to EM shielding in digitizer sensors.

An aspect of some embodiments of the present invention is the provision of systems and methods for EM shielding of conductive lines of a digitizer sensor over an area that extends beyond the grid area of the sensor. Typically, the digitizer comprises a frame over which part of the conductive lines and surrounding electronic components are situated. Typically, the part of the conductive lines that extends beyond the area defined by the grid is situated on the frame. The present inventors have found that a user's finger and/or hand resting and/or hovering over the frame can cause capacitive coupling effects which might result in undesired finger touch detection over that area. For example, finger touch around the frame can lead to false finger detection. In some embodiments, finger touch around the frame area can lead to inaccuracy with stylus and/or other object detection within the grid detection when the signals provoked by finger and/or hand touch provoke a signal in the frequency range used by the stylus.

According to some embodiments of the present invention conductive shielding is applied on the part of the sensor lines positioned in the vicinity of the frame and/or beyond viewing area of the display screen associated with the digitizer sensor. Typically, the area defined by the frame includes conductive pads used for electrical connection with electrical components and/or circuitry of the digitizer sensor. According to some embodiments of the present invention, conductive shielding is applied over conductive pads of the digitizer sensor. According to some embodiments of the present invention conductive shielding is additionally applied over and/or around surrounding electronic components.

Optionally, the conductive layer is grounded. Optionally, the conductive layer is electrically connected to the digitizer.

According to some embodiments of the present invention, the conductive layer is integral to the digitizer sensor. According to some embodiments of the present invention, the conductive layer is integral to the digitizer sensor module. According to one embodiment of the present invention, the conductive layer is integral to a host computing device used with the digitizer. Optionally, the conductive shielding is applied on a top cover of the host computing device.

According to some embodiments of the present invention, conductive shielding is provided by carbon ink. Optionally, the conductive shielding comprises a conductive sheet. Optionally the conductive shielding comprises silver. Optionally, the conductive shielding comprises a transparent conductive material. Optionally, the conductive shielding comprises a non-transparent conductive material.

According to some embodiments of the present invention, conductive shielding is only applied on the edges of the conductive grid that include conductive pads.

Optionally, when the conductive layer is formed on the four edges of the sensor, the conductive layer is cut off so as not to form a closed loop circuit. This configuration is used in order to prevent energy transfer from the excitation coil surrounding the sensor to the conductive layer.

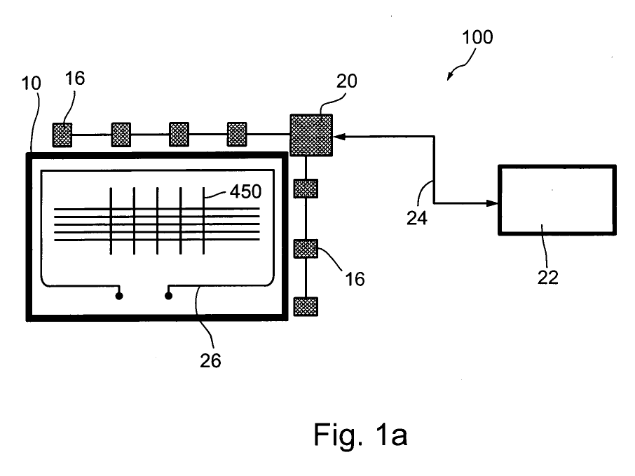

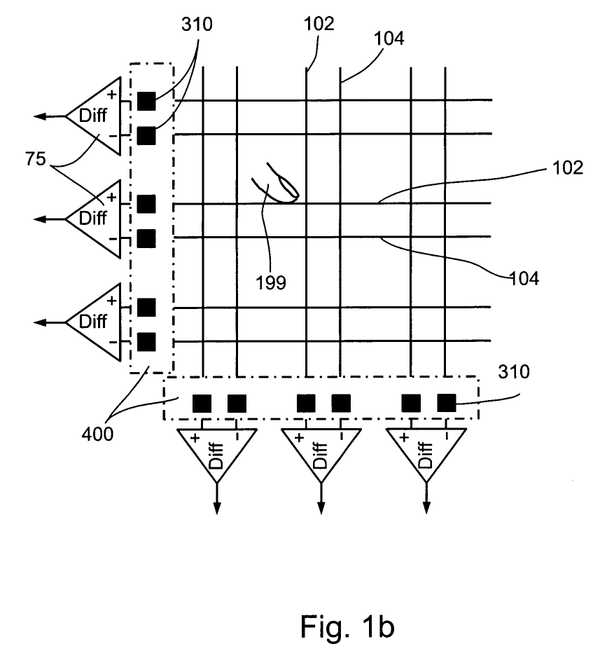

Referring now to the drawings, FIG. 1 illustrates an exemplary simplified block diagram of a digitizer system in accordance with some embodiments of the present invention. The digitizer system 100 shown in FIG. 1 may be suitable for any computing device that enables interactions between a user and the device, e.g. mobile computing devices that include, for example, FPD screens. Examples of such devices include Tablet PCs, pen enabled lap-top computers, PDAs or any hand held devices such as palm pilots and mobile phones. According to some embodiments of the present invention, the digitizer system comprises a sensor 450 including a patterned arrangement of conducting lines, which is optionally transparent, and which is typically overlaid on a FPD 10. Typically sensor 450 is a grid based sensor including horizontal and vertical conducting lines.

According to some embodiments of the present invention, an ASIC 16 comprises circuitry to process and sample the sensor's output into a digital representation. The digital output signal is forwarded to a digital unit 20, e.g. digital ASIC unit, for further digital processing. The outcome, once determined, is forwarded to a host. 22 via an interface 24 for processing by the operating system or any current application. In some exemplary embodiments, ASIC 16 and digital unit 20 may be provided as a single ASIC.

Typically, ASIC 16 is connected via conductive pads to outputs of the various conductors in the grid and functions to process the received signals at a first processing stage. ASICs 16 typically include an array of amplifiers, e.g. differential amplifiers, to amplify the sensor's signals. Additionally, ASIC 16 optionally includes one or more filters to remove frequencies that do not correspond to frequency ranges used for excitation and/or obtained from objects used for user interactions. The signal is then sampled by an A/D, optionally filtered by a digital filter and forwarded to digital ASIC unit, for further digital processing.

According to some embodiments of the invention, digital unit 20 receives the sampled data from ASIC 16, reads the sampled data, processes it and determines and/or tracks the position of physical objects, such as stylus, finger and/or other conductive and/or electro-static objects touching the digitizer sensor. According to some embodiments, digital unit 20 and ASIC 16 track position of both multiple objects on the digitizer sensor, including tracking a position of both finger touch and stylus input together on the sensor. According to some embodiments of the present invention, digital unit 20 determines the presence and/or absence of physical objects, such as stylus, finger and/or other conductive objects over time. In some exemplary embodiments of the present invention hovering of an object, e.g. stylus, finger and hand, is also detected and processed by digital unit 20. Calculated position is sent to the host computer via interface 24.

According to some embodiments, digital unit 20 produces and manages a triggering pulse to be provided to an excitation coil 26 that surrounds the sensor arrangement and the display screen. The excitation coil provides a trigger pulse (in the form of an electric or electromagnetic field) that excites passive circuitry in a stylus or other object used for user interaction to produce a response from the stylus that can subsequently be detected.

According to some embodiments, digital unit 20 produces and sends a triggering pulse to at least one of the conductive lines. According to some embodiments of the present invention, the triggering pulse and/or signal implemented may be confined to one or more pre-defined frequencies, e.g. 18 KHz.

Digitizer systems used to detect stylus and/or finger tip location may be, for example, similar to digitizer systems described in incorporated U.S. Pat. No. 6,690,156, U.S. patent application Publication No. 7,292,229 and/or U.S. Patent Application Publication No. 20040155871. It will also be applicable to other digitized and/or touch screen systems known in the art, depending on their construction.

Reference is now made to FIG. 1B showing pairs of conductive lines of digitizer sensor connected to differential amplifiers in accordance with some embodiments of the present invention. According to some embodiments of the present invention, the pairs of lines 102 and 104 connected to inputs of differential amplifiers 75 are interrogated to determine if there is a finger 100 or stylus near them. This interrogation can be serial (only one pair at a time is queried) or concurrent (a plurality or all the pairs are queried together). In an embodiment of the invention to query the pair, capacitive touch detection is implemented and one or more signal sources, e.g. an AC signal source induces an oscillating signal in conductive lines 102 and 104 of sensor 450. When finger 100 is placed on a sensor's conductive line, say conductive line 102, a capacitance develops between the finger and the conductive line. As there is a potential between conductive line 102 and the user's finger, current passes from conductive line 102 through the finger to ground. Consequently a potential difference is created between conductive line 102 and it paired conductive line 104, both of which serve as input to differential amplifier 75. The separation between the two conductive lines 310 and 320 is typically greater than the width of the finger so that the necessary potential difference can be formed.

According to some embodiments of the present invention, the conductive lines of the digitizer sensor are connected to inputs of the differential amplifiers using conductive pads 310. According to some embodiments of the present invention, touch detection over the conductive pads is not desired as it typically does not overlap a viewing area and/or an area intended for user interaction. According to some embodiments of the present invention, conductive shielding is applied over the conductive pads so as to prevent detection. Since conductive layer 400 is at uniform electrical potential, any signal which is created due to a finger, stylus and/or other conductive object placed over the conductive pads causes a common signal on all the conductive pads covered by the conductive shield and therefore is not detected at the output of the differential amplifier. As such the effect of objects, e.g. fingers, positioned over areas of the sensor not intended for user interaction is cancelled.

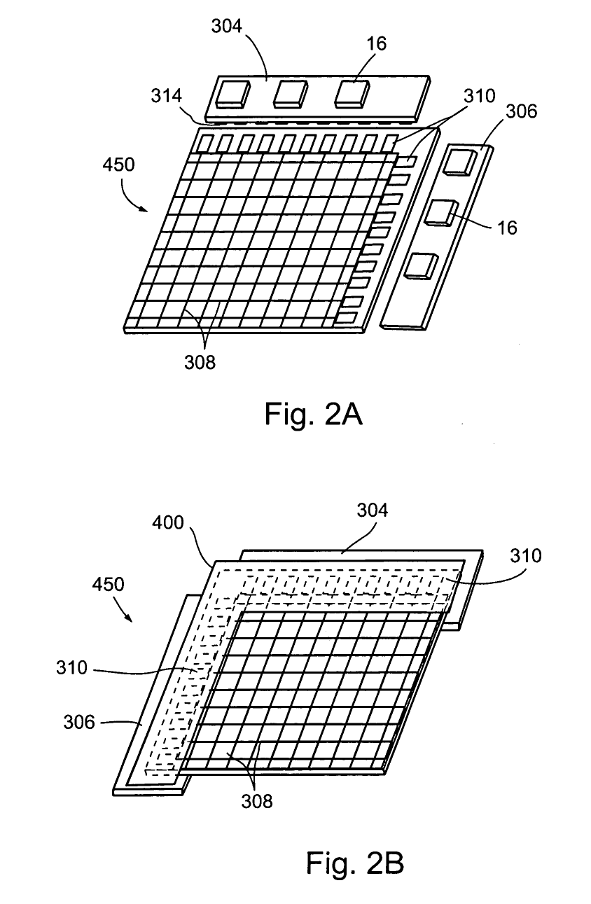

Reference is now made to FIGS. 2A and 2B. FIG. 2A shows a simplified diagram of one face of a sensor array and PCBs to be connected to the sensor array, in accordance with some embodiments of the present invention. FIG. 2B shows the opposite face of the sensor array shown in FIG. 2A with mounted PCBs and including conductive shielding over the conductive pads, in accordance with some embodiments of the present invention.

In FIG. 2A, exemplary sensor grid and/or sensor array 450 is shown in proximity to a first PCB substrate 304 and a second PCB substrate 306. Optionally, an L-shape PCB is used instead of two PCB substrates 304 and 306. According to some embodiments of the present invention, sensor array 450 is comprised of transparent PET foils and/or glass layers, each patterned with conductive antennas and/or lines 308. According to some embodiments of the present invention, sensor array 450 is comprised of transparent PET foil or other transparent layer, patterned with conductive antennas and/or lines 308 on both sides of the foil or layer. Optionally, sensor array 450 is comprised of glass substrates, each patterned with conductive antennas and/or lines 308. According to some embodiments of the present invention, sensor array 450 is comprised of glass substrate, patterned with conductive antennas and/or lines 308 on both sides of the glass. In some exemplary embodiments, conductive lines 308 are made of ITO or other transparent organic conductors. Optionally, they are made of very narrow metallic conductors, which do not substantially obscure a view of a screen behind the sensor. The transparent foils are combined to create a grid of conductive lines 308.

According to some embodiments of the present invention, each conductive line 308 is connected to and/or formed with one of a plurality of electrical conductive elements, such as conductive pads 310, at or near the edge and/or edges of the foils. Typically, the conductive pads are on the face of the sensor array shown FIG. 2A. In some exemplary embodiments, the conductive pads are made of graphitic or silver material or carbon material. Typically, conductive pads 310 are not required to be transparent since they overlap with PCB 304 and 306 which are typically opaque and are over part of the sensor array that is not intended for user interaction. According to some embodiments of the present invention, first PCB substrate 304, is assigned to the x-axis line and second PCB substrate 306 is assigned to the y-axis line. Optionally, more or less PCBs are used depending on the configuration of the sensor array or functionality considerations, e.g. two L-shaped PCB may be used. Digital ASIC 20 may be mounted on one of PCBs 304 and 306 or may be on a separate PCB, typically also surrounding sensor array 450.

In an exemplary embodiment of the invention, PCB 304 and 306 include conductive pads 314 at the bottom of the PCB substrates and during assemble are electrically connected to conductive pads 310 on the transparent foils. Optionally, connection between conductive pads 310 and 314 is by conductive glue. In some exemplary embodiments, PCB conductive pads 314 at the bottom of the PCB substrates are electrically connected to the conductive lines of the transparent foils of the sensor and conductive pads 310 are excluded. Optionally, conductive pads 314 are made of nickel coated with gold.

According to embodiments of the present invention, during assembly, PCB substrates 304 and 306 are mounted on conductive pads 310 and sensor array 450 is positioned over a display, e.g. an LCD display such that the PCB substrates and ASICs 16 and digital ASIC 20 are surrounding the LCD display and facing it.

According to embodiments of the present invention, in operation, a user interacts with the sensor array from the face of the sensor array shown in FIG. 2B. User interactions on sensor array 450 generate electric signals on conductive lines 308 and/or changes in electric signals on the conductive lines. The received signals are transferred to the PCB substrates 304, 306 through the electric contacts provided by the conductive pads 310 and 314.

According to embodiments of the present invention, conductive shielding 400 is applied over an area of the conductive pads 310 to shield the pads from EM transmission due to stylus touch, finger touch, and/or other EM signals from the surrounding environment. Shielding is applied to exclude the area over the conductive pads from user interaction with the digitizer. In some exemplary embodiments, the conductive shielding can prevent potential capacitive coupling effects due to a stylus and/or finger accidentally positioned over the area of the conductive pads. Such effects may lead to false and/or inaccurate position detection of other objects on the sensor grid and/or un-intended user interaction detection. It is noted that the sensors may utilize grid lines in which the end away from the circuitry is open circuited.

In some exemplary embodiments, conductive shield 400 is in the form of a graphical print on the edges of sensor 450, e.g. forming a decorative graphical frame that is visible to the user.

Typically pairs of conductive lines are input to differential amplifiers included in ASIC 16 mounted on PCB substrates 304 and 306 to amplify differences in the received signals. Typically, close but non-adjacent parallel lines are input to the differential amplifier. Optionally, the conductive layer is grounded, e.g. connected to ground. Optionally, the conductive layer is electrically connected to the digitizer, e.g. connected to ground or other power plane of the PCB.

According to some embodiments of the present invention, conductive layer 400 is made from carbon ink. Optionally, the conductive layer is made from silver and/or graphite and/or other suitable conductive materials. Typically, conductive shielding 400 is not required to be transparent, e.g. made from transparent conductive material, since it is positioned over an area that is not intended for user interaction, although in some embodiments, transparent conductive material may be suitable and is used. According to embodiments of the present invention, conductive shielding is made from a layer of conductive ink, conductive sheet and/or a conductive mesh.

According to embodiments of the present invention, sensor array 450 includes conductive pads 310 on two edges of the sensor and an L shaped conductive shield is used to shield conductive pads 310. In other exemplary embodiments, conductive layer 400 covers all four edges of sensor array 450 and shielding also covers the edges without conductive pads. Typically, when all four edges of the sensor are shielded part of the conductive layer is cut off so as not to form a closed loop circuit. In some exemplary embodiments, sensor array 450 does not include conductive pads and conductive layer 400 is applied to shield areas of the grid not intended for touch detections, e.g. areas overlapping with PCBs 304 and 306 and/or other area which extend beyond the viewing area of the LCD.

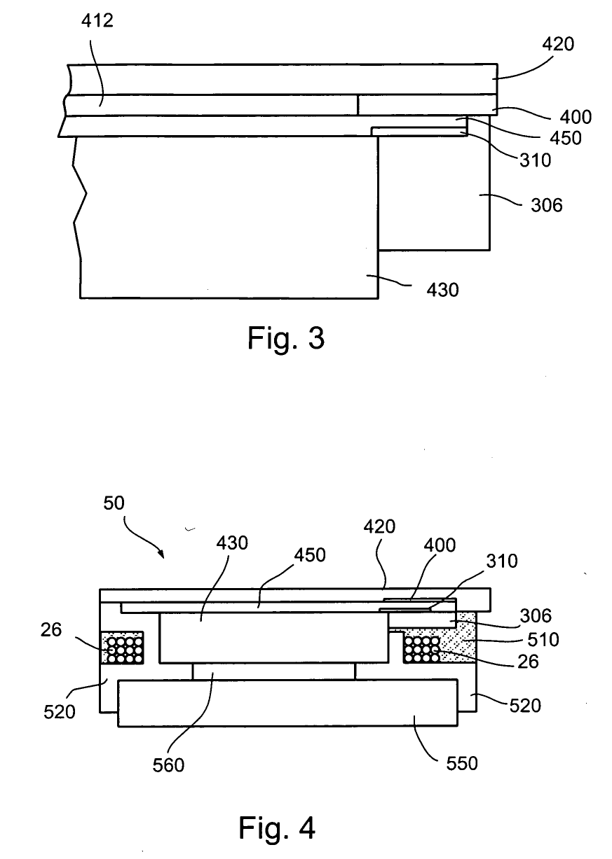

Reference is now made to FIG. 3 showing a simplified cross sectional view of the sensor array with PCB including shielding in accordance with some embodiments of the present invention. According to some embodiments of the present invention, sensor array 450 is manufactured on a substrate 430, which is typically a transparent material, e.g. glass substrate. Optionally, a cover film 420 is secured on the sensor grid with an adhesive 412, e.g. a transparent adhesive, to cover the sensor grid and provide a surface over which a user can interact with the digitizer sensor. A stylus and/or finger touching cover film 420 provide EM transmission and/or capacitive coupling effects that can be detected by one or more lines of the sensor grid and may be identified with the surrounding circuitry, e.g. PCB 306.

According to some embodiments of the present invention, conductive shielding 400 is provided between the sensor array 450 and the cover film 420 to shield at least the conductive pads 310 which is typically in an area of the sensor grid not intended for position detection, e.g. an area beyond a viewing area. Typically, conductive pads 310 and conductive shield 400 are distance from each other by the thickness of the sensor grid 450 so that there is no direct electrical contact between the conductive pads and the conductive shield. In some exemplary embodiments, conductive shielding 400 is directly applied on sensor array 450. In some exemplary embodiments, conductive shielding 400 is directly applied on cover film 420. According to some embodiments of the present invention, conductive shield 450 is formed on the sensor and therefore is a part of the sensor module and the digitizer assembly.

Reference is now made to FIG. 4 showing a simplified cross sectional view of the sensor module overlaid on an FPD (or other) display in accordance with some embodiments of the present invention. According to some embodiments of the present invention, sensor module 50 includes a sensor array 450 overlaid on a glass substrate 430, one or more PCBs, e.g. PCB 306, a sensor frame 520 and a peripheral coil 26 winded around the sensor plane. Frame 520 provides mechanical stability to sensor array 450, secures peripheral coil 26 to a fixed position, and keeps the sensor module aligned with the LCD 550. According to some embodiments of the present invention, PCBs positioned around sensor array 450, e.g. PCB 306, include the digital ASIC controller 20, several analog ASICs 16, pads 314 to enable the connection to the sensor's grid, a plurality of conductive lines facilitating electrical communication between components. Optionally a flex cable connects one or more PCB to the host. In some exemplary embodiments, the sensor module is mounted on top of the display screen (such as LCD) using adhesive strips. Optionally an air gap 560 is formed between the glass substrate and the LCD. According to embodiments of the present invention, sensor module 50 is similar to sensor module described in US Patent Publication No. 20070292983 incorporated herein by reference in its entirety. According to some embodiments of the present invention, conductive shield 400 is applied on the edges of the sensor that connect to the PCBs.

According to some embodiments of the present invention the display screen can be for example the display of a tablet PC, a cell phone, a computer monitor, Personal Digital Assistants (PDA), or wireless FPD.

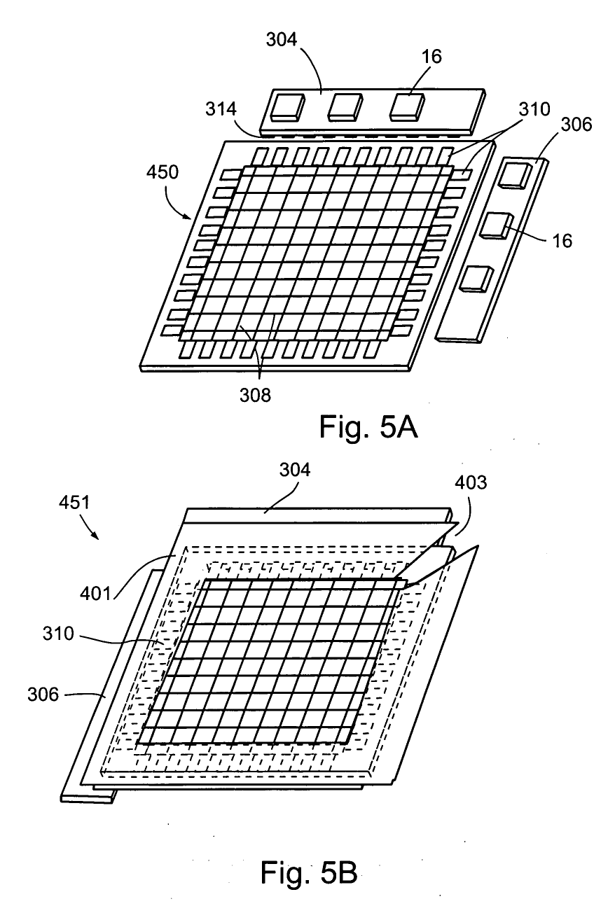

Reference is now made to FIGS. 5A and 5B. FIG. 5A shows a simplified diagram of a sensor array including conductive pads on four edges and PCBs to be connected to the sensor array, in accordance with some embodiments of the present invention. In some exemplary embodiments, pads on opposite edges of the conductive lines can facilitate testing the sensor, e.g. testing conductive transmittance of the line, resistance of the line etc. FIG. 5B shows the opposite face of the sensor array shown in FIG. 5A with mounted PCBs and including conductive shielding over the conductive pads on four edges of the sensor array, in accordance with some embodiments of the present invention.

According to some embodiments of the present invention, although conductive pads 310 appear on all edges of sensor array 451, PCBs 304 and 306 are positioned over two edges of sensor array 451. Optionally, circuitry and/or PCBs are positioned on all four edges of sensor array 451 and connect to conductive pads 310 on all four edges. According to some embodiments of the present invention, conductive shielding is applied on all four edges to shield all the conductive edges. Typically, in such a case a section of the conductive shield is cut-off, e.g. area 403 so as not to form a closed loop circuit that could potentially prevent energy transfer from the excitation coil surrounding the sensor to the conductive layer.

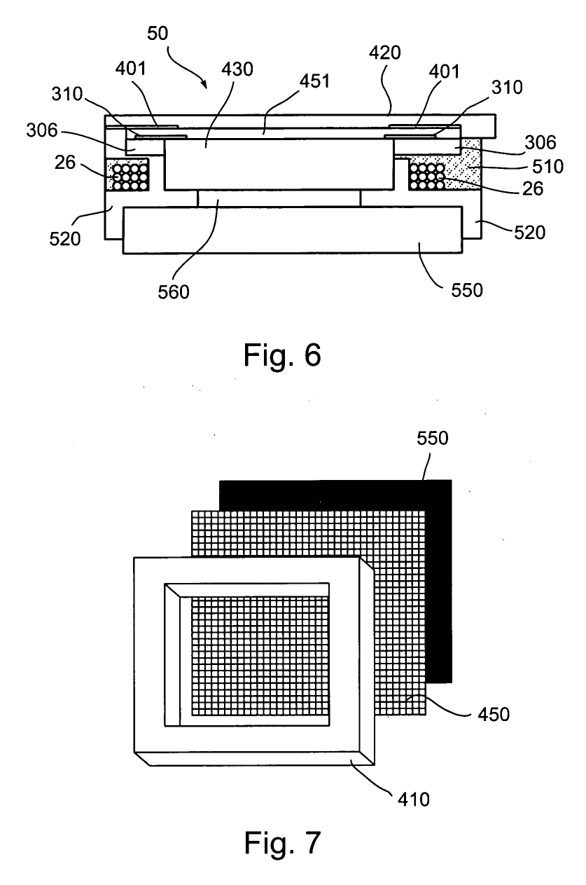

Reference is now made to FIG. 6 showing a simplified cross sectional view of the sensor module including shielding on both edges of the sensor array overlaid on an FPD display in accordance with some embodiments of the present invention. According to the embodiment shown, sensor 451 includes conductive pads 310, circuitry and conductive shielding 401 on all four edges of sensor array 451.

Reference is now made to FIG. 7 showing a sensor module including a frame covering with shielding in accordance with some embodiments of the present invention. According to some embodiments of the present invention, sensor module 50 is mounted on top of the display screen 550, e.g. an: LCD and is optionally covered by a top cover 410. According to some embodiments of the present invention, a conductive layer 401 is printed on a top cover 410 and/or directly on the cover film 420 (shown FIGS. 3, 4, 6) and includes an area which extend beyond the sensor array. Optionally, the conductive layer can also function as a graphic design surrounding of the display screen. The conductive shield over frame 410 can be in addition and/or as a replacement for conductive shield 400 or 401. According to another embodiment of the present invention, the conductive layer is a part of the host computing device and can be formed, for example, on the top cover of the host device. Typically, the conductive shield is implemented to block signals on the sensor, e.g. block object detection on the areas covered by the conductive shield.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

What is claimed is:

1. A digitizer comprising:
a sensor configured for detecting an object implemented for user input, the sensor including at least one transparent layer;
circuitry connected to the sensor configured for processing signals detected on at least a portion of the sensor; and
a conductive shield configured for providing shielding over an area of the sensor that is not intended for user input.

2. The digitizer according to claim 1 wherein the at least one transparent layer is patterned with conductive lines, to create a grid of conductive lines.

3. The digitizer according to claim 2 wherein the circuitry is connected to at least a portion of the conductive lines.

4. The digitizer according to claim 2 wherein the circuitry is connected to at least a portion of the conductive lines from a first face of the sensor array and the conductive shield is overlaid on the opposite face of the sensor array.

5. The digitizer according to claim 2, wherein at least some of the conductive lines are connected to a plurality of conductive pads at or near the edge of the sensor array, the conductive pads configured for establishing electrical contact with the circuitry.

6. The digitizer according to claim 5 wherein the conductive pads are formed on a first face of the sensor array and the conductive shield is overlaid on an opposite face of the sensor array and over at least an area defined by the conductive pads.

7. The digitizer according to claim 2 wherein the circuitry includes at least one differential amplifier configured for detecting a difference between at least one pair of conductive lines.

8. The digitizer sensor according to claim 7, wherein the conductive shield is at a uniform potential and is configured for canceling a difference between the at least one pair of conductive lines, wherein the difference is due to an object positioned in an area of the sensor not intended for user input.

9. The digitizer according to claim 1 wherein the at least one transparent layer is manufactured from foil or glass.

10. The digitizer according to claim 1 wherein the detecting is by a capacitive based detection.

11. The digitizer according to claim 1 wherein the conductive shield is configured for providing shielding over an area proximal to at least one edge of the sensor.

12. The digitizer according to claim 1 wherein the conductive shield is an integral part of the sensor.

13. The digitizer according to claim 1 wherein the conductive shield is an integral part of the digitizer.

14. The digitizer according to claim 1 comprising a cover film configured for providing a surface over which a user can interact with the sensor, wherein the conductive shield is applied between the cover film and the sensor.

15. The digitizer according to claim 1 comprising a cover film configured for providing a surface over which a user can interact with the sensor, wherein the conductive shield is applied on the surface over which a user can interact with the sensor.

16. The digitizer according to claim 1 wherein the circuitry includes at least one printed circuit board mounted on at least one edge of the sensor array.

17. The digitizer according to claim 1 wherein the conductive shield is applied on the sensor array proximal to two edges of the sensor array.

18. The digitizer according to claim 1 wherein the conductive shield is at a uniform potential.

19. The digitizer according to claim 1 wherein the sensor includes conductive lines forming a grid and wherein the conductive shield is applied on the sensor over an area extending beyond the area defined by the grid.

20. The digitizer according to claim 1 wherein the sensor is over-laid on a display screen and is configured for correlating the user input with visual information portrayed on the display.

21. The digitizer according to claim 20 wherein a portion of senor array extends beyond a viewing area of the display screen and wherein the conductive shield is configured for covering that portion of the sensor array.

22. The digitizer according to claim 1 wherein the digitizer sensor is integrated with a host computing device including a cover positioned over part of the sensor and wherein the conductive shield is applied on the cover.

23. The digitizer according to claim 1 wherein the conductive shield is formed from a transparent material.

24. The digitizer according to claim 1 wherein the conductive shield is connected to ground.

25. The digitizer according to claim 1, wherein the conductive shield is electrically connected to the circuitry.

26. The digitizer according to claim 1 wherein the object is selected from a group including a finger, a stylus, a capacitive object and an electro-static object.

27. The digitizer according to claim 1, wherein the digitizer is configured for detecting both finger touch and stylus input.

28. The digitizer according to claim 1 wherein the sensor array includes at least two transparent layers, each layer patterned with conductive lines, wherein the transparent layers are combined to create a grid of conductive lines.

29. The digitizer according to claim 1, wherein the conductive shield is a graphical print applied on one or more edges of the sensor.
